(19) United States
(12) Patent Application Publication
(10) Pub. No.: US 2009/0266745 A1
(43) Pub. Date: Oct. 29, 2009

(54) METHOD FOR REMOVING HYDROFLUORIC ACID AND ORGANIC FLUORIDES FROM A FLUID STREAM

(76) Inventors: Vladislav I. Kanazirev, Arlington Heights, IL (US); Jayant K. Gorawara, Buffalo Grove, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/108,192

(22) Filed: Apr. 23, 2008

(51) Int. Cl. C10G 17/00

(52) U.S. Cl. 208/262.1

(57) ABSTRACT

A method is provided for removing HF and organic fluorides from fluid streams in which the fluoride species exist as impurities and, in particular, from hydrocarbon fluid streams containing no more than about 1.0% by weight total fluorides. The method consists of first contacting the fluid stream first with a nonpromoted alumina and then with an adsorbent consisting essentially of activated alumina that has been treated with a promoter material selected from the oxides and phosphates of alkali metals and alkaline earth metals, and mixtures thereof. This is preferably accomplished by providing a suitable absorber vessel charged with the adsorbent in a fixed bed, and then contacting the fluoride-contaminated fluid through the fixed bed.

### BACKGROUND OF THE INVENTION

This invention relates to a compound adsorbent bed for removing hydrofluoric acid (HF) and related organic fluorides from fluid streams in which they are contained as impurities, and in particular, from hydrocarbon fluid streams in petroleum refineries. This invention further relates to a method of using this compound adsorbent to remove HF and related organic fluoride compounds from fluid streams in which they are contained as impurities and, in particular, from hydrocarbon streams downstream from acid catalyzed alkylation processes.

The alkylation reaction as practiced in petroleum refining involves the condensation of an olefin (ethylene, propylene, butylenes, and amylenes) with isobutane to yield high-octane branched-chain hydrocarbons in the gasoline boiling range. Alkylation can be accomplished as a thermal, thermal-catalytic, or catalytic reaction. HF alkylation is a catalytic reaction in which the HF is used as the catalyst.

As a result of the use of the HF catalyst, HF alkylation unit effluent streams inevitably contain trace levels, up to several hundred parts per million by weight, of fluoride-containing compounds, including hydrogen fluoride, organic fluorides, or mixtures thereof. These fluorides are considered to be impurities or contaminants in the effluent stream and must be removed in order to avoid corrosive effects and also in order to meet product specifications.

The organic fluorides are formed in the HF alkylation reactor by the addition of HF with an unsaturated or olefinic hydrocarbon. One or more of the products from an HF alkylation unit operation may be treated for fluoride removal depending upon the end use of the product.

Standard petroleum refining industry practice removes organic fluorides and residual free HF in the effluent streams of petroleum refining acid catalyst alkylation units by means of fixed bed decomposition and adsorption using high surface area activated alumina as the catalyst/adsorbent media. These fixed bed absorbers are referred to as defluorinators. The term high surface area activated alumina refers to an aluminum oxide compound of the general formula AL₂OH₂O having an extended surface area of above about 100 m²/g, preferably above about 150 m²/g. Activated alumina fluoride scavengers are widely applied in both gas and liquid streams as guard beds. Alumina has a dual role—first to catalyze the decomposition of organic fluoride species and, second, to bind the fluorine as AlF₃. However, secondary reactions in the main stream causes the guard bed to coke up. This decreases the potential for alumina to bind fluorine. In U.S. Pat. No. 6,632,368, it was discussed that use of alkali metal promoted alumina solves the coke formation problem. However this also strongly reduces the decomposition activity of the guard bed towards organic fluoride decomposition activity. As a result, premature organic fluoride breakthrough may happen, especially at high fluoride concentrations in the main stream. Thus, improvements in the industrial processes for fluoride removal are needed.

The free HF is removed from the process stream by subsequent reaction with the alumina to form aluminum trifluoride.

### SUMMARY OF THE INVENTION

The present invention constitutes a new method for removing HF and related organic fluorides from fluid streams in which the fluoride species exist as impurities and, in particular, from hydrocarbon fluid streams containing approximately 1000 ppm(w) combined fluorides. The invention is used to purify effluent from HF alkylation reactions as well as other applications when HF is used in combination with hydrocarbons. The method of the invention consists of contacting the fluid stream first with a nonpromoted alumina adsorbent in the inlet portion of an adsorbent bed while a second adsorbent comprising activated alumina promoted with a compound selected from the oxides and phosphates of alkali metals and alkaline earth metals, and mixtures thereof fills up the remaining portion of the bed. The non-promoted alumina adsorbent and the activated promoted alumina may be present as separate layers within a single adsorbent bed or they may be in separate adsorbent beds. The invention combines a solid material able to catalyze the decomposition reaction with a high capacity scavenger for HF. As a result higher fluoride removal capacity per unit bed volume is achieved.

Bases utilized in this invention include alkaline and alkaline earth metal oxides and phosphates, and mixtures thereof. Particularly, the sodium, calcium, magnesium and potassium oxides and phosphates. When the base is an oxide, the activated alumina is promoted with Na₂O and K₂O, and preferably with Na₂O. When the activated alumina is promoted with a phosphate, it may be selected from the group consisting of the phosphates of Li, Na, K, Be, Mg and Ca and, preferably, potassium phosphate. Cumulative promoter levels (oxide+phosphate) comprise between about 0.5 and about 25 wt-% of the activated alumina product.

The invention provides benefits beyond those found with a single adsorbent system, either promoted or nonpromoted.

### DETAILED DESCRIPTION OF THE INVENTION

### Adsorbent Preparation

Methods for activation of alumina are well known in the art. One technique that has been found to be particularly useful is described in U.S. Pat. No. 2,915,365 (Saussol), incorporated herein by reference. In a common method of obtaining an activated alumina, an alumina hydrate, e.g. bauxite, is heated at a high temperature generally for a very short period of time in a process known as flash calcination. Typically, flash activation involves calcination at temperatures of 400° to 1000° C. with contact times of the order of 1 to several seconds, typically about 1 second. During this activation, the alumina starting material is converted from a very low surface area hydrate to a high surface area material, typically having a surface area above 100 m²/g.

As a starting material to obtain the activated alumina, any number of various aluminas or alumina containing materials can be employed. For example, essentially pure aluminas such as alumina trihydrate, pseudoboehmite, or alpha alumina monohydrate can be used. A particularly convenient source of alumina starting material is gibbsite, a form of alumina trihydrate, which is manufactured by the well-known Bayer process. This product is readily available commercially and typically has a particle size of 90-100 microns. In addition, the alumina containing material can comprise materials such as bauxite or, indeed, can be other alumina bearing sources such as beneficiated clays. Another useful source of alumina containing materials are aluminas, e.g. boehmite, obtained from the hydrolysis of aluminum alkoxides. In general, the starting material alumina should have a minimum alumina (Al₂O₃) content of at least about 40% by weight calculated on the basis of its dry weight, i.e., after ignition at 1000° C. for one hour. The promoted alumina used in the adsorbent of the present invention should be reduced in size to the 1-25 micron range, either before or after being flash calcined, but in any event before being formed and promoted with alkali metal- or alkaline earth metal oxide according to the invention.

Methods of product forming are also well known to those skilled in the art. For example, one forming process utilizes a rotating pan to which is fed both dry activated alumina-based solid and water or aqueous-based solution. In this process, the activated alumina powder is fed to the pan nodulizer at a steady rate using a metered feed system. Water or an aqueous solution is sprayed onto and mixed with the alumina powder while in the constantly rotating pan. This process steadily turns the alumina powder into spheres whose finished size is dictated by the degree of tilt of the pan and the speed of the pan's rotation. Typical formed adsorbent product sizes range from 2 mm to 4 mm in diameter. The formed material is then allowed to cure for some period of time, which may vary from several minutes to several days, under specific temperature and humidity conditions. The cured material is then thermally re-activated at a temperature between 300° to 550° C., yielding an active formed product.

Promotion of the activated alumina after it has been activated is carried out by treating the alumina with alkali- or alkaline earth metal oxides and/or phosphates. This may be accomplished by one of three principal methods, each well known in the art, or some combination thereof: Dry-blending involves incorporation of the promoter species by addition of the dry promoter or promoter precursor to the freshly activated alumina powder prior to the forming step. The dry component mixture is then blended with water or an aqueous solution during forming to yield a homogeneous mixture of promoted product. Co-forming involves incorporation of the promoter species during the forming step in which freshly activated alumina powder is re-hydrated with the addition of water during product forming. In the co-forming process, the promoter species is dissolved in the water, resulting in the formed promoted product. Impregnation involves the incorporation of the promoter species after the final thermal activation of the formed product by wetting the product with an aqueous solution containing the promoter species.

In cases where the promoter material has been introduced by impregnation, a simple drying procedure to remove excess water is generally the only additional processing step that needs to be performed. It will be understood, in this regard, that there are commercially available activated aluminas that can be employed as the alumina-containing material suitable for impregnating with the promoter material salt solution.

The invention offers a better solution for fluoride removal problem by using a compound guard bed whereas a non-promoted alumina adsorbent is placed in the inlet portion of the bed followed by a promoted alumina adsorbent. The UOP activated alumina adsorbent A-202HF can be used in the inlet portion while another UOP adsorbent should fill up the remaining portion of the compound bed. Both adsorbents listed above are currently in use in defluorination service. Similar guard bed materials are also offered by other alumina producers. The invention combines a solid material capable to catalyze the decomposition reaction with a high capacity scavenger for HF. As a result, higher fluoride removal capacity per unit bed volume is achieved.

The invention combines a solid catalyst for organic fluoride removal with a high capacity fluoride scavenger. Activated alumina is a known material used as a guard bed in HF alkylation units. Activated alumina works as both catalyst and scavenger. Moreover, there is a sequence of four reactions as noted below:

CₙH₂ₙ₊₁F═C₂H₂ₙ+HF (1)

Al₂O₃+yHF═Al₂O_{3-y}/2F_{y}+y/2H₂O (2)

xCnH₂n—oligomers—carbon residue—coke (3)

Al₂O₃+6HF=2AlF₃+3H₂O (4)

As the material picks up first portions of HF (reaction 2), it becomes more catalytically active. As a result, the rate of decomposition reaction (1) is enhanced. Unfortunately, the rate of the side reactions of oligomerization and coke formation (3) also increase. The consequence is that the coke formation prevents the desired scavenging reaction (4) from going to completion. Hence, the conversion of alumina to AlF₃ is less than 100%. Values of 70 to 75% conversion and carbon deposition of 3 to 5 mass-% are typical for the cases where activated aluminas are applied.

It is also known that an attenuation of the detrimental catalytic activity of traditional fluoride scavengers can be achieved by using modified alumina adsorbents in which an alkali metal, such as sodium, neutralizes the acidic function of alumina. The application of such materials results in better conversion of alumina to AlF₃ approaching 100% if the conditions are right. Residual carbon on the adsorbent is rarely above 0.5% which shows that the side reaction (3) does not proceed at a significant rate. Unfortunately, the attenuated catalytic activity in the case of these modified alumina adsorbents may not be enough to carry out the primary reaction (1) of organic fluoride decomposition. In that case, no HF is formed and the scavenging process slows down or even completely stops. It is also known that the organic fluorides differ in reactivity depending on their structure. Generally, a tertiary fluoride would be more reactive compared to a secondary fluoride and significantly more than a primary fluoride. Thus, the catalytic activity of the modified alumina could be not sufficient to decompose all the fluorides in the feed in the range of fluoride concentrations applicable—from few parts per million to a few thousand parts per million.

The problems described above are solved with the present invention by combining in the same guard bed, two different materials—a catalytic alumina or other suitable material capable of decomposing organic fluorides and a modified alumina which has exclusively the scavenging function with respect to HF without side reaction. In a typical example, catalytic alumina would not occupy more that 20% of the bed volume and would be placed at the bed inlet.

Use of a combined bed successfully employs a catalytic portion facilitates the organic fluoride decomposition while the scavenging portion accomplishes the HF removal. The relative proportion of the catalytic part of the bed is typically less than 20% of the whole bed. It is most advantageously located at the bed inlet. This is the first known solution of solving the problem of HF removal from alkylation feed by decoupling the HF scavenging process from the organic chloride decomposition and allowing each process to proceed in a dedicated portion of the combined bed.

In the present invention, the preferred form of the adsorbent is as nodules, such as spheres. However, it will be recognized that any shape can be employed. Thus, cylindrically shaped pellets, irregular lumps, or virtually any other shape can be employed. In cases where the promoter material has been introduced in a dry-blending or co-forming production process in conjunction with the use of a thermally activated alumina, e.g. bauxite, alumina trihydrate, and the like, it is necessary to cure and thermally re-activate the formed product.

### Removal of Fluorides from Fluids

The compound adsorbent of the present invention can be readily employed in the removal of fluorides from an industrial fluid, i.e., gas and liquid, stream in which the fluorides exist in low concentrations and are considered as a contaminant, or impurity. The fluid stream to be treated will typically contain less than about 1.0% by weight fluoride compounds and may contain less than about 1000 ppm of fluorides (HF plus organic fluorides). Generally, the removal is accomplished by providing a suitable absorber vessel charged with the adsorbent in sufficient quantity to form a fixed bed, and then conducting the HF-contaminated fluid through the fixed bed. Preferably, the non-promoted alumina is located near the inlet to the adsorbent bed and the promoted alumina takes up the remaining portion of the bed. The fluorides are removed from the fluid stream, as discussed earlier, by a catalyzed scavenging process of converting organic fluorides to HF and adsorbing the HF on the adsorbent as the fluid passes through the fixed bed. More efficient scavenging occurs with the use of a nonpromoted alumina to perform the scavenging function. The fluid stream that is treated passes through the adsorbent bed at a temperature between about 100° to 325° C. Preferably, the fluid stream passes through the adsorbent bed at a temperature between about 175° to 250° C.

It has been observed that the best scavenging activity can be achieved when the streams being treated contain no more than about 1.0% by weight of total fluorides. Larger quantities of fluorides in the streams can be treated but, unless special consideration is given to the size of the bed and the flow rate of the fluid stream through the bed, premature saturation of the adsorbent scavenger may result, with the possibility of having an undesired early breakthrough and consequent corrosion and environmental problems.

HF adsorption beds are typically configured as dual bed systems with beds oriented in series with lead-lag piping. Purification of fluoride-contaminated fluid streams according to the present invention is generally continued until the fluid exiting from the lead (primary) absorber bed is observed to have HF content above a desired pre-determined level. At this point, the lead bed is taken off line for adsorbent replacement. The fresh bed is then brought back on-line in the lag (secondary) position, with the previous lag bed being switched into the lead position. This cycling can thus continue indefinitely without interruption to service and no suffering of temporary HF breakthrough.

1. A method for removing hydrofluoric acid and organic fluorides from a fluid stream, comprising passing said fluid stream through at least one adsorbent bed comprising at least one layer of a nonpromoted alumina and at least one layer of an activated alumina which has been promoted with a compound selected from the oxides and phosphates of alkali metals and alkaline earth metals, and mixtures thereof.

2. The method of claim 1 wherein said fluid stream is an effluent stream from a hydrofluoric acid (HF) alkylation unit.

3. The method of claim 1 wherein said fluid stream contains less than about 1.0% by weight of said HF and said organic fluorides.

4. The method of claim 1 wherein said fluid stream passes through said at least one adsorbent bed at a temperature between about 100° to 325° C.

5. The method of claim 1 wherein said fluid stream passes through said at least one adsorbent bed at a temperature between about 175° to 250° C.

6. The method of claim 1 wherein the activated alumina is promoted with a promoter selected from the group consisting of the phosphates of Li, Na, K, Be, Mg and Ca.

7. The method of claim 1 wherein the promoter is potassium phosphate.

8. The method of claim 1 wherein the activated alumina is promoted with sodium oxide.

9. The method of claim 1 wherein the promoter comprises between about 0.5 and about 25 wt-% of the activated alumina.

10. The method of claim 1 wherein the fluid stream contains less than about 1000 ppm total HF and organic fluorides.

11. The method of claim 1 wherein said one layer of a nonpromoted alumina and said at least one layer of an activated alumina are in a single adsorbent bed.

12. The method of claim 1 wherein said one layer of a nonpromoted alumina and said at least one layer of an activated alumina are in separate adsorbent beds.
